(19) United States
(12) Patent Application Publication
(10) Pub. No.: US 2007/0287055 A1
(43) Pub. Date: Dec. 13, 2007

(54) Fuel cell system

(76) Inventor: Hideyuki Ueda, Osaka (JP)

Correspondence Address: MCDERMOTT WILL & EMERY LLP, 600 13TH STREET, NW, WASHINGTON, DC, 20005-3096, US

(21) Appl. No.: 11/808,813

(22) Filed: Jun. 13, 2007

(30) Foreign Application Priority Data
Jun. 13, 2006 (JP) 2006-163176

(51) Int. Cl. H01M 8/04

(52) U.S. Cl. 429/34

(57) ABSTRACT

A fuel cell system includes a fuel cell stack which is composed of an assembly of fuel cells, each of which is provided with an anode that is supplied with fuel and a cathode that is supplied with oxygen. The fuel cell system further includes an air duct for supplying oxygen, which is disposed along the fuel cell stack, and at least a fuel tank and a recovery tank unit of a gas-liquid separator, namely, a tank for supplying water to be mixed with fuel, which both are disposed on a side opposite to the fuel cell stack with the air duct interposed therebetween. Accordingly, vaporization of fuel due to heat generated in the fuel cell stack which is the power generating section is suppressed, and a deterioration of generating characteristics attributable to insufficient fuel supply is prevented.

The present disclosure relates to subject matter contained in priority Japanese Patent Application No. 2006-163176 filed on Jun. 13, 2006, the contents of which is herein expressly incorporated by reference in its entirety.

### BACKGROUND OF THE INVENTION

1. Field of the Invention

The present invention relates to a fuel cell system and, in particular, to an arrangement of a fuel tank and a tank for supplying water to be mixed with the fuel, which both are provided in such a system.

2. Description of the Related Art

Recently, many fuel cell systems are proposed, including stationary-type fuel cell systems, a typical example of which is a fuel cell system for cogeneration facilities, and non-stationary-type fuel cell systems such as those for electric automobiles, those for mobile electronic equipment, and the like. An example of non-stationary-type fuel cell systems is a direct oxidation-type fuel cell in which a fuel is directly supplied to the anode. This type of fuel cells could be used as a ubiquitous mobile power source that does not require charging through an AC adapter, and its research and development are being actively conducted in this field.

In the direct oxidation-type fuel cell, oxidation of a fuel takes place at the anode, and reduction with oxygen takes place at the cathode. Reaction equations of a direct methanol-type fuel cell that uses methanol as a fuel are given below.

Anode: CH₃OH+H₂O→CO₂+6H⁺+6e⁻ (1)

Cathode: 3/2O₂+6H⁺+6e⁻→3H₂O (2)

As can be seen from Equation (1), reaction at the anode requires methanol and water. However, if both methanol and water are to be supplied externally, then a tank or cartridge that stores a fuel must be provided with a space for storing water, which in turn lowers energy density per volume. For this reason, in a typical direct methanol-type fuel cell, part of water generated at the cathode according to Equation (2) is collected and recycled within the system.

For example, in order to realize miniaturized lightweight fuel cells or sustained operation for a long period of time, a non-circulating fuel (fully consumed)/circulating water (recovered)-type fuel cell system is known (for example, see Japanese Patent Laid-Open Publication No. 2005-25959). This fuel cell is based upon a philosophy that, with a fuel being prepared to a predetermined concentration, the fuel cell is operated with a fuel supply of an exact amount to be consumed during power generation so that the fuel is neither recovered nor recycled but only water is recovered to be recycled.

An example of a structure of this type of fuel cell system will be described with reference to FIG. 2. Reference numeral 11 designates a fuel cell stack, which is composed of a plurality of layered fuel cells. A fuel of a predetermined concentration stored in a fuel tank 12 and water stored in a recovery tank unit 13a of a gas-liquid separator 13 are supplied to a mixing tank 16 by a first pump 15 through valves 14a and 14b, respectively, so that the fuel is diluted to a predetermined concentration. The diluted fuel is then supplied to the anode of the fuel cell stack 11 by a second pump 18 through a valve 17. On the other hand, air is supplied to the cathode of the fuel cell stack 11 by a fan 19. Accordingly, electricity is generated in the fuel cell stack 11.

Also proposed is a circulating-type fuel cell system, in which not only the water is recovered, but also fuel and water discharged from the anode and the cathode, respectively, of the fuel cell are temporarily recovered and then mixed with a concentrated fuel stored in a fuel tank to prepare a fuel of a predetermined concentration. The prepared fuel is then used again to generate electricity. In this circulating-type fuel cell system, it is necessary to cool the discharge from the anode at high temperatures so that vaporization of fuel is suppressed and a certain level of fuel utilization efficiency is ensured. For example, another fuel cell system is known (for example, see Japanese Patent Laid-Open Publication No. 2005-293974). This fuel cell system is equipped with a first heat exchanger and a second heat exchanger, the first heat exchanger exchanging heat with a first tank that stores a concentrated fuel, and the second heat exchanger exchanging heat with a second tank that dilutes the concentrated fuel. The discharge from the anode at high temperatures due to reaction heat during power generation is cooled by allowing it pass through these heat exchangers and then fed into a gas-liquid separator to ensure a certain level of fuel utilization efficiency. In addition to this, the fuel in the first and second tanks is supplied to the anode of the fuel cell after being heated by these heat exchange operations.

By the way, because of the oxidation of fuel in the fuel cell stack 11, namely, in the power generating section, the temperature there rises to approximately 60° C. even during normal operation. If a concentrated fuel is used, then the crossover of fuel increases, and a considerable amount of heat is produced at the power generating section. Thus, if the fuel tank 12 and the recovery tank unit 13a of the gas-liquid separator 13 are disposed adjacent to the fuel cell stack 11 as illustrated in FIG. 2, then the temperatures of fuel and water rise, and their vaporization amounts increase, resulting in a shortage of fuel to be supplied to the fuel cell stack 11 by the pump. This tendency is more significant if the arrangement is such that the heat exchange takes place with the discharge from the anode at high temperatures as in the fuel cell system disclosed in the above-mentioned Japanese Patent Laid-Open Publication No. 2005-293974.

As a result, overpotential becomes large on the anode side, which causes elution of a ruthenium catalyst or corrosion of carbon as described by Equation (3) below.

C+2H₂O→CO₂+4H⁺+4e⁻ (3)

This causes further problem associated with reduction in CO poisoning resistance, reduction in utilization efficiency of a platinum catalyst, missing MPL structure of the diffusion layer, and the like, thereby making it difficult to maintain a certain level of power generation.

### SUMMARY OF THE INVENTION

The present invention has been devised in light of the above-mentioned conventional problems, and an object of the present invention is to provide a fuel cell system that suppresses vaporization of fuel due to heat generated in the fuel cell stack serving as a power generating section, and prevents a deterioration of generating characteristics attributable to insufficient fuel supply.

A fuel cell system of the present invention includes: a fuel cell stack which is composed of an assembly of fuel cells each of which is provided with an anode which is supplied with a fuel and a cathode which is supplied with oxygen; an air duct for supplying oxygen, which is disposed along the fuel cell stack; and at least a fuel tank and a tank for supplying water to be mixed with the fuel which both are disposed on a side opposite to the fuel cell stack with the air duct interposed therebetween.

According to this structure, since the air duct is present between the fuel cell stack which is the power generating section as well as the heat generating section, and the fuel tank and the tank for supplying water to be mixed with the fuel, the fuel and a mixture of the fuel and water are prevented from being heated to high temperatures due to the heat generated in the fuel cell stack. This prevents the fuel that would otherwise be of high temperatures or a fuel that would otherwise be mixed with high temperature water and would thus become high temperature fuel from being vaporized when it is being fed to the fuel cell stack, thereby suppressing the risk of insufficient fuel supply. A deterioration of generating characteristics attributable to the insufficient fuel supply to the fuel cell stack is, therefore, prevented. Vaporization of water is also prevented at the same time, and thus an amount of water required for power generation is secured. Furthermore, since air supplied to the fuel cell stack is warmed up in advance by heat from the fuel cell stack when it passes through the air duct, a temperature difference between the inlet and the outlet of the cathode becomes small, and the uniformity of in-plane generating capability within the fuel cell stack is ensured, thereby improving power generation efficiency.

Furthermore, if the above-mentioned tank for supplying water is a recovery tank unit of a gas-liquid separator, the recovery tank unit does not become too hot. This, in turn, improves separating capability of the gas-liquid separator, and the recovered water can be counted in when securing an amount of water required for power generation.

According to the fuel cell system of the present invention, the fuel tank and the tank for supplying water are not disposed adjacent to the fuel cell stack, namely, the power generating section, but the air duct is disposed therebetween. This suppresses the vaporization of fuel due to heat generated in the fuel cell stack, thereby preventing a deterioration of generating characteristics attributable to insufficient fuel supply to the fuel cell stack. Furthermore, since air to be supplied to the fuel cell stack is warmed up in advance, a temperature difference between the inlet and the outlet of the cathode is made small, and the uniformity of in-plane generating capability within the fuel cell stack is ensured, thereby improving power generation efficiency.

The above and other objects and characteristics of the present invention will become more apparent when the following detailed descriptions are referred to with reference to the accompanying drawings.

### BRIEF DESCRIPTION OF THE DRAWINGS

FIG. 1 is a block diagram schematically illustrating one embodiment of a fuel cell system according to the present invention; and

FIG. 2 is a block diagram schematically illustrating a conventional fuel cell system.

### DETAILED DESCRIPTION OF THE PREFERRED EMBODIMENTS

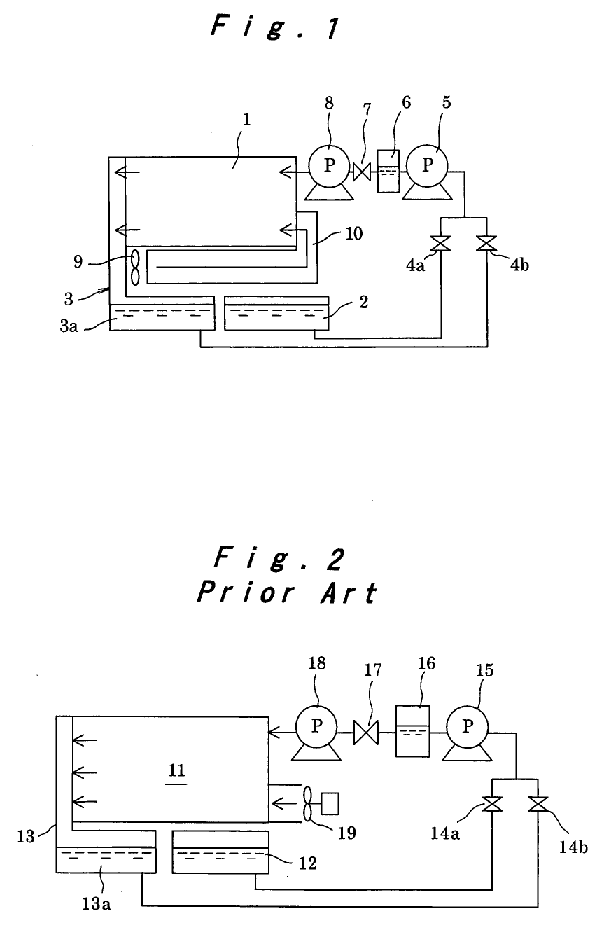

Hereinafter, a fuel cell system according to an embodiment of the present invention will be described with reference to FIG. 1.

In FIG. 1, reference numeral 1 designates a fuel cell stack that is composed of a plurality of layered fuel cells where a membrane electrode assembly (MEA) is disposed counter to a separator channel surface. Reference numeral 2 designates a fuel tank that stores a fuel such as methanol or dimethyl ether of a predetermined concentration. Reference numeral 3 designates a gas-liquid separator that separates vapor and liquid from discharges from the anode and the cathode of the fuel cell stack 1 and recovers the liquid, and reference numeral 3a designates a recovery tank unit that stores water thus separated and recovered. The vapor separated by this gas-liquid separator 3, or equivalently, carbon dioxide generated during power generation and remaining air except oxygen consumed are discharged to the atmosphere, and water generated during power generation is recovered to the recovery tank unit 3a. The gas-liquid separator 3 is preferably made of a gas-liquid separating membrane because of its compactness in structure.

A fuel in the fuel tank 2 and water in the recovery tank unit 3a are fed into a mixing tank 6 at predetermined flow rates by a first pump 5 with valves 4a and 4b being switched appropriately, thereby diluting the fuel to a predetermined concentration. Then, the fuel evenly diluted to a predetermined concentration in the mixing tank 6 is supplied to the anode of the fuel cell stack 1 by a second pump 8 through a valve 7. Furthermore, air is supplied to the cathode of the fuel cell stack 1 by a fan 9 through an air duct 10.

Accordingly, the fuel diluted to a predetermined concentration and air are supplied to the anode and the cathode, respectively, of the fuel cell stack 1, and the before-mentioned reactions of Equations (1) and (2) take place at each fuel cell in the fuel cell stack 1, generating electricity between the anode and the cathode. Power generated in all the fuel cells is then sent out as an output from an output terminal of the fuel cell stack 1.

In the present embodiment, with the fuel cell system having the above-mentioned structure, the air duct 10 is disposed along and adjacent to the fuel cell stack 1, and the fuel tank 2 and the recovery tank unit 3a of the gas-liquid separator 3 are disposed on the side opposite to the fuel cell stack 1 with the air duct 10 interposed therebetween. In addition to this, thermal insulators may be provided in the vicinities of the inlet and the outlet of the anode of the fuel cell stack 1 so that it prevents heat from the fuel cell stack 1 from reaching the fuel supply system or the gas-liquid separator 3.

According to the structure of the present embodiment, since the air duct 10 is present between the fuel cell stack 1 which is the power generating section as well as the heat generating section, and the fuel tank 2 and the recovery tank unit 3a of the gas-liquid separator 3, the fuel or a mixture of the fuel and water is prevented from being heated to high temperatures due to the heat generated at the fuel cell stack 1. This prevents the fuel that would otherwise be of high temperatures by being directly subjected to heat or by being mixed with high temperature water from being vaporized when it is being fed to the fuel cell stack 1, thereby suppressing the risk of insufficient fuel supply to the fuel cell stack 1. It further prevents elution of a ruthenium catalyst or corrosion of carbon, which is attributable to the insufficient fuel supply to the fuel cell stack 1. A deterioration of generation characteristics due to reduction in CO poisoning resistance, reduction in utilization efficiency of a platinum catalyst, missing MPL structure of the diffusion layer, or the like is also prevented. Vaporization of water is also prevented, and therefore an amount of water required for power generation is secured.

Furthermore, since air supplied to the fuel cell stack 1 is warmed up in advance by heat from the fuel cell stack 1 when it passes through the air duct 10, a temperature difference between the inlet and the outlet of the cathode becomes small, and the uniformity of in-plane generating capability within the fuel cell stack 1 is ensured, thereby improving power generation efficiency.

Furthermore, since the recovery tank unit 3a of the gas-liquid separator 3 does not become too hot, the separating capability of the gas-liquid separator 3 is in turn improved, and recovered water can be counted in when securing an amount of water required for power generation. Though, in the present embodiment, the recovery tank unit 3a of the gas-liquid separator 3 is used as a tank for supplying water to be mixed with a fuel, the present invention is not limited to this configuration. Even in the case where a separate water tank is provided, water in such a tank is prevented from being heated to high temperature due to the heat from the fuel cell stack 1, thereby obtaining similar function and effect.

In the fuel cell system of the present invention, methanol, dimethyl ether, or the like is directly used as a fuel without reforming to obtain hydrogen. Furthermore, by suppressing vaporization of fuel due to heat generated in the fuel cell stack, a deterioration of generating characteristics attributable to insufficient fuel supply is prevented. Therefore, the present invention is useful not only as a power source for mobile electronic equipment such as mobile phones or personal data assistants (PDA), notebook computers, video cameras, and the like but also as a power source for electric scooters, automobiles, or the like.

While preferred embodiments of the invention have been described using specific terms, such description is for illustrative purposes only, and it is to be understood that changes and variations may be made without departing from the spirit or scope of the following claims.

What is claimed is:

1. A fuel cell system comprising:
a fuel cell stack which is composed of an assembly of fuel cells each of which includes an anode which is supplied with a fuel and a cathode which is supplied with oxygen;
an air duct for supplying oxygen, which is disposed along the fuel cell stack; and
at least a fuel tank and a tank for supplying water to be mixed with the fuel which both are disposed on a side opposite to the fuel cell stack with the air duct interposed therebetween.

2. The fuel cell system according to claim 1, further comprising a gas-liquid separator having a recovery tank unit, and wherein the recovery tank unit serves as the tank for supplying water.
